(19) United States
(12) Patent Application Publication
(10) Pub. No.: US 2005/0233042 A1
(43) Pub. Date: Oct. 20, 2005

(54) Flavourant compounds

(75) Inventors: Christophe Galopin, Cincinnati, OH (US); Andreas Goeke, Duebendorf (CH); Stefan Michael Furrer, Cincinnati, OH (US)

Correspondence Address: NORRIS, MCLAUGHLIN & MARCUS, 875 THIRD AVE, 18TH FLOOR, NEW YORK, NY, 10022, US

(73) Assignee: Givaudan SA, Vernier (CH)

(21) Appl. No.: 10/522,113

(22) PCT Filed: Jul. 23, 2003
(86) PCT No.: PCT/CH03/00500

§ 371 Date: Jan. 25, 2005

Related U.S. Application Data
(60) Provisional application No. 60/398,449, filed on Jul. 25, 2002.

(51) Int. Cl. A23L 1/22

(52) U.S. Cl. 426/534

(57) ABSTRACT

Use as a flavour ingredient of an aliphatic or aromatic unsaturated amide of formula (I).

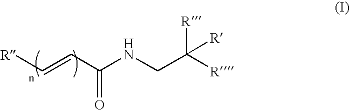

This invention relates to flavourant molecules for use in foods and beverages.

New and interesting flavour ingredients are always being sought. To be of any practical use for flavourists, ingredients are needed that not only possess interesting organoleptic properties, but they should also be inexpensive to produce and stable during long periods of storage and to processing conditions that may comprise elevated temperatures and humidity, and extremes of pH.

Highly flavoured and pungent compounds are particularly valued in southern Asian cuisine. Typical of these are certain sanshool derivatives. However, a problem with the known sanshool derivatives is that they are unstable; they tend to polymerise easily and are therefore difficult to store over prolonged periods and are difficult to incorporate in processed consumables that create conditions promoting instability.

Thus, the prior art goes no further than to make certain empirical observations concerning the organoleptic properties of these compounds. It does not give any hint or suggestion as to problems with instability, and so naturally does not teach solutions for overcoming instability. Further, the art does not provide any technical teaching as to the influence of the compounds' structure on their organoleptic properties.

It has now been found that certain aliphatic and aromatic unsaturated amides are easily synthesised, are relatively stable during manufacture and under storage and processing conditions commonly experienced in the manufacture of consumables, and possess interesting pungent odours and leave a pleasing tingling sensation in the mouth. Therefore, the invention provides in a first aspect the use as a flavour ingredient of at least one compound according to the formula (I) 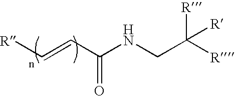
wherein,
R′ is H, or OH, and n is 1 or 2, R″ being selected such that
(a) when n=2, R″ is a group of the formula 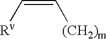
   wherein m is 1, 2 or 3;
R′″ and R′″ are independently selected from H, C1-C4 alkyl, benzyl, or
R′″ and R′″ together with the carbon atom to which they are attached form a 5- or 6-membered carbocyclic ring,
R^{V} is alkyl or alkenyl or a substituted alkyl or unsubstituted alkenyl that does not contain any aliphatic conjugated double bonds, and is preferably a linear or branched alkyl group having from 1 to 6 carbon atoms, or a linear or branched alkenyl group having 2 to 6 carbon atoms;
   or
(b) when n=1, R″ is selected from a group as described under (a) and a phenyl group.

Use of these compounds as flavouring compounds gives to food a pungent note and imparts a pleasant tingling sensation in the mouth. The invention therefore also provides a method for imparting a pungent flavour to a food product, comprising the addition to the food product of a compound of the type hereinabove described.

The compounds hereinabove described are not prone to polymerisation. The compounds share common functional features that may be characterised by one or two double bonds in the trans configuration adjacent the carbonyl group, and a further double bond, provided in the group R″ that is in the cis-configuration. This trans-cis, or trans-trans-cis configuration is important to preserve the pungent flavour note. Furthermore, the group Rv can tolerate additional unsaturation but it must not contain any conjugated unsaturation, unless the conjugated unsaturation is present in an aromatic motif such as a phenyl group. It is believed that aliphatic conjugated saturation in this part of the molecule results in instability and a tendency for the molecules to polymerise. In contradistinction to the prior compounds mentioned above, none of the compounds of formula (I) contain such functionality. This functionality is essential for achieving these desirous properties, and is entirely unpredictable having regard to the prior art.

Some of the abovementioned compounds are novel. Therefore, the invention also provides a compound of the formula

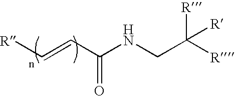

wherein the moieties therein are selected according to the following table:

| Compound | R′ | R″ | R″′ | R″″ | n |
|---|---|---|---|---|---|
| 1 | H | B | Methyl | Methyl | 2 |
| 2 | OH | C | Methyl | Methyl | 2 |

wherein B and C are each a group of the formula 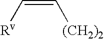
wherein in B R^{v} is an ethyl radical; and in C R^{v} is a methyl radical.

Compounds for use in the present invention may be prepared according to synthetic procedures known in the art from readily available starting materials.

Aliphatic unsaturated amides of formula (I) may be prepared in a one-pot synthesis, coupling diethyl N-substituted phosphonoacetamide and an appropriately substituted aldehyde using butyl lithium in a suitable dry solvent such as THF according to classic Wittig-Horner-Emmons chemistry. The N-substituted phosphonoacetamide may be N-isobutyl phosphonoacetamide and the aldehyde may be nonadienal, although the skilled person will understand that other starting aldehydes that are commonly available or can be made according to known syntheses from available starting materials, may be employed to provide compounds of the present invention.

Aromatic unsaturated amides according to formula (I) are likewise formed by a simple synthetic protocol, using an appropriately substituted amine and cinnamic acid or an appropriately substituted cinnamic acid, or in the case of n=2 the 5-phenyl-penta-2,4dienoic acid, or substituted 5-phenyl-penta-2,4dienoic acid. Further details relating to the synthesis of the compounds of formula (I) are disclosed in the Examples set forth in detail below.

A compound for use in the present invention imparts a pungent, spicy note to consumables. It also leaves a pleasant tingling sensation in the mouth without any attendant burning or pain sensation. A compound of the present invention or a mixture thereof may be used as a flavour ingredient in flavour compositions. A compound or mixture of compounds may be blended with other flavour ingredients in said compositions. A compound or mixture of compounds imparts a particularly interesting note to all kinds of savoury food products and also to beverages, and is also interesting in enhancing the performance of coolant compounds or compositions.

In addition to their combination with other flavour ingredients, flavour compositions may contain additional excipients that are commonly employed in the art for improving or enhancing the performance of food or beverage products, for example preservatives, colourants, emulsifiers and encapsulating materials and formulations.

Flavour compositions as herein above described may be added to processed consumables during their processing, or they may actually be consumables in their own right, e.g. condiments such as sauces and the like.

The flavourant qualities of compounds of the formula (I) may be evident over a broad range of concentrations. For example, in the case of a food product such as soups, condiments and the like, a compound or mixture of compounds may be present in amounts ranging from 0.01 to 1.0% by weight, whereas, in the case of a beverage, such as alcoholic or soft drinks, a compound or a mixture thereof may be present in a concentration ranging from 0.0001 to 500 mg/kg.

Whereas the compounds of formula (I) are described as flavourant ingredients, their unusual property of providing a tingling sensation, and their organoleptic properties may be usefully employed in personal care products or cosmetics, that are to be topically applied whereupon they may impart a fresh tingling sensations. In such compositions, they may be applied in amounts ranging from 0.01 to 10% by weight, more preferably 0.1 to 1% by weight.

There now follows a series of nonlimiting examples that serve to illustrate the invention.

### EXAMPLE 1

### N-isobutyl E2, E4, Z8-undecatrienamide (Compound 1 in the Table above)

In a procedure based on a published method (Tetrahedron Lett. 1985, 26 (20), 2477-2480), at 0° C., in a round-bottom flask under an inert atmosphere of nitrogen, a solution of 2.77 g (11 mmol) of diethyl N-isobutyl phosphonoacetamide in 20 mL of dry tetrahydrofuran is added to 15.5 mL of a 1.5M solution of butyl lithium (23 mmol) in hexane. The mixture is stirred at 0° C. for thirty minutes. A solution of 1.4 g of E2,Z6-nonadienal in 5 mL of dry tetrahydrofuran is then added dropwise to the stirred reaction mixture. The mixture is stirred at 0° C. for two hours. The reaction mixture is then diluted in 100 mL of hexane and washed with a saturated aqueous solution of ammonium chloride. The organic phase is collected and dried over anhydrous magnesium sulfate, filtered and concentrated. The residue is purified by chromatography on silica gel to give 0.5 g of product as a white fluffy powder.

1H NMR (δ in ppm): 7.2 (doublet of doublet), 6.1 (multiplet), 5.75 (doublet), 5.34 (multiplet), 3.2 (triplet), 2.2 (multiplet), 2.0 (quintuplet), 1.8 (septuplet), 0.96 (triplet), 0.93 (doublet).

### EXAMPLE 2

### Preparation of 3-phenyl-acryloyl chloride

In a round-bottom flask under an inert atmosphere of nitrogen, a mixture of 37.04 g (0.25 mol) of cinnamic acid, 44.6 g [0.375 mol] of thionyl chloride and 2 drops of pyridine were heated at reflux for 4 h. The red mixture was concentrated (40° C./125 mbar) and 42.7 g of a brownish oil were recovered.

### Preparation of 3-phenyl-N-butyl-acrylamide

In a round-bottom flask under an inert atmosphere of nitrogen, a mixture of 4.1 g [25 mmol] of 3-phenyl-acryloyl chloride, 25 ml of dry tetrahydrofuran, 5 ml of pyridine was added. 1.77 g [30 mmol] of iso-butylamine was added over a period of 30 min at room temperature. The mixture was stirred for 5 h at room temperature. The reaction mixture was diluted with methyl t-butyl ether and extracted with water. The organic phase was washed with aqueous hydrochloric acid (1N) and brine, dried over anhydrous magnesium sulfate, filtered and concentrated. The residue was crystallized from MTBE/hexane to give 4.1 g of product as a yellowish fluffy powder.

¹H NMR (δ in ppm): 7.6 (doublet, 1H), 7.5 (multiplet, 2H), 7.4 (multiplet, 3H), 6.4 (doublet, 1H), 5.8 (singlet, broad, 1H), 3.4 (quartet, 2H), 1.6 (sixtuplet, 2H), 1.0 (triplet, 3H).

### EXAMPLE 3

### Deca-2,4,8-trienoic acid methyl ester

To a solution of 4-(diethoxy-phosphoryl)-but-2-enoic acid methyl ester (11.6 g, 49.2 mmol) in THF (70 ml) was added KOtBu (5.98 g, 49.2 mmol) at 0° C. The mixture was cooled to −78° C. and a solution of (Z)-hex-4-enal (4.00 g, 40.8 mmol) in THF (10 ml) was added dropwise. After the cooling bath was removed and the mixture had warmed up to room temperature, sat. NH₄Cl was added and the mixture was extracted with pentane. The organic phase was washed with water and brine, dried (MgSO₄) and concentrated in vacuo. The residue was distilled bulb to bulb (90° C./0.01 Torr) to yield (8Z, 2E)-deca-2,4,8-trienoic acid methyl ester (2.4 g, 33%) as a 7/3 mixture of the (4E/Z)isomers.

¹H-NMR (200 MHz, CDCl₃): 7.69-7.20 (m, 1H), 6.29-5.31 (m, 5H), 3.76, 3.74 (2s, 3H, OMe), 2.45-2.13 (m, 4H), 1.61 (d, J=6.5 Hz, 3H, 10H) ppm; MS (EI): 180 (M⁺, 2), 149 (6), 121 (10), 111 (27), 93 (28), 67 (51), 59 (32), 55 (100), 39 (35), 29 (28). IR (neat): 3015m, 2949m, 1720s, 1644m, 1435m, 1264s, 1137m cm⁻¹.

### Deca-2,4,8-trienoic acid (2-hydroxy-2-methyl-propyl)-amide (Compound 2 in the Table above)

Deca-2,4,8-trienoic acid methyl ester (1.90 g, 10.56 mmol) was saponified with NaOH (2.11 g, 52.8 mmol) in H₂O/MeOH (5/1, 60 ml) during 2d. The crude reaction mixture was acidified with HCl (2N) to pH=1 and extracted 5 times with MTBE. The organic phase was washed with brine, dried (MgSO₄) and concentrated in vacuo. The residue was dissolved in CH₂Cl₂ (30 ml) containing a drop of DMF and treated over night with oxalyl chloride (2.0 g, 15.7 mmol). The solvent was removed in vacuo (while keeping the temperature at ˜20° C.), the residue was redissolved in CH₂Cl₂ (10 ml) and added to a solution of 1-amino-2-methyl-propan-2-ol (1.1 g, 12.4 mmol) and triethyl amine (1.5 g, 15 mmol) in CH₂Cl₂ (20 ml). The mixture was stirred for 5 h and was then quenched with water and extracted with CH₂Cl₂. The organic phase was washed with 1N HCl, water and brine, dried (MgSO₄) and concentrated in vacuo. (2E,8Z)-Deca-2,4,8-trienoic acid (2-hydroxy-2-methyl-propyl)-amide (2.0 g, 80%) crystallized from ethyl acetate/hexane as a 7/3 mixture of the (4E/Z)isomers in form of slightly yellow crystals.

(4E)-Isomer: ¹HNMR (400 MHz, CDCl₃): 7.19 (dd, J=15.0 Hz, 10.3 Hz, 1H, 3H), 6.56 (bt, J=6.0 Hz, 1H, NH), 6.19-6.03 (m, 2H, 4,5H), 5.86 (d, J=15.0 Hz, 1H, 2H), 5.52-5.44 (m, 1H), 5.39-5.32 (m, 1H), 3.49 (s, 1H, OH), 3.33 (d, J=6.0 Hz, 2H, NH—CH₂), 2.25-2.13 (m, 4H, 6,7-H), 1.60 (d, J=6.5 Hz, 3H, 10-H) ppm. MS (EI): 237 (M⁺, 4), 179 (62), 164 (13), 149 (23) 124 (48), 110 (100), 94 (22), 84 (25), 66 (30), 59 (47), 55 (88), 41 (24), 30 (34). IR (neat): 3287br(OH), 2974m, 2931m, 1658s, 1627s, 1609s, 1537s, 1179m, 1161m, 996m, 913m cm⁻¹.

### EXAMPLE 4

A flavour composition is formed of the following ingredients:

80 g Vegetable oil
6.153 g Black pepper oil
4.338 g alpha-phellandrene
2.8575 g caryophyllene
0.72 g ginger oil
0.696 g compound 2
0.1135 g 4-terpinenol
0.0540 g linalool
0.03 g cedar leaf oil
0.018 g celery seed oil

The ingredients are thoroughly mixed before adding “Tween” (trade mark) surfactant 80 q. s. 100. Additional mixing is performed until a clear, pale to medium yellow liquid is obtained.

When this liquid is added to a soup at 0.2%, the above formula adds a pleasurable pungency and tingling sensation to the soup.

1. A compound according to the formula (I) 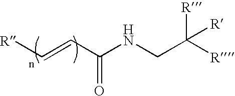
or mixtures thereof wherein,
R′ is H, or OH, and
R″ is a phenyl radical; or phenyl substituted with C1-C4 alkyl or alkoxy; or a group 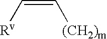
wherein m is 1, 2 or 3
R′″ and R″″ are independently selected from H, C1-C4 alkyl, benzyl, or
R′″ and R″″ together with the carbon atom to which they are attached form a 5- or 6-membered carbocyclic ring,
R^{v} is alkyl or alkenyl or a substituted alkyl or unsubstituted alkenyl that does not contain any aliphatic conjugated double bonds, and
n is 1 or 2.

2. A compound according to claim 1 wherein R′ is OH.

3. A compound according to claim 1 wherein n is 1.

4. A compound according to claim 1 selected from the group consisting of

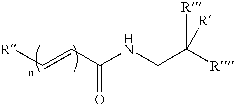

| Compound | R′ | R″ | R′″ | R″″ | n |
|---|---|---|---|---|---|
| Aromatic | H | A | Methyl | Methyl | 1 |
| Structure 2 | H | B | Methyl | Methyl | 2 |
| 85-0344 | OH | C | Methyl | Methyl | 2 |
| 85-0960 | OH | D | Methyl | Methyl | 2 |
| 85-2492 | OH | B | Methyl | Methyl | 2 |
| 85-2493 | H | E | Methyl | Methyl | 2 |

according to the foregoing table, wherein, in the be table A is phenyl and B, C, D and E, are representative of the group 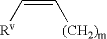
wherein in
B Rv is an ethyl radical
C Rv is a methyl radical, and
D Rv is a cis-pent-2-enyl radical
E Rv is an n-pentyl radical

5. Use of a compound according to claim 1 as an ingredient in flavour compositions.

6. A flavour composition according comprising a compound or mixture of compounds as defined in claim 1.

7. A food product containing a compound of formula (I) defined in claim 1 or mixtures thereof in amounts of 0.001 to 10% by weight.

8. A beverage product containing a compound of formula (I) defined in claim 1 or mixtures thereof in amounts of 0.0001 to 500 mg/Kg.

9. A personal care product or cosmetic product containing a compound of formula (I) defined in claim 1 or mixtures thereof in amounts of 0.01 to 10% by weight.
